(19) United States
(12) Patent Application Publication
(10) Pub. No.: US 2007/0183625 A1
(43) Pub. Date: Aug. 9, 2007

(54) Statistical Match For Facial Biometric To Reduce False Accept Rate/False Match Rate (FAR/FMR)

(76) Inventors: Jeffrey A. Dussich, New York, NY (US); McKen King Hang Mak, Forest Hills, NY (US)

Correspondence Address: SUGHRUE MION, PLLC, 2100 PENNSYLVANIA AVENUE, N.W., SUITE 800, WASHINGTON, DC, 20037, US

(21) Appl. No.: 11/668,324

(22) Filed: Jan. 29, 2007

Related U.S. Application Data
(60) Provisional application No. 60/762,524, filed on Jan. 27, 2006.

(51) Int. Cl. G06K 9/00

(52) U.S. Cl. 382/100

(57) ABSTRACT

This invention encompasses a method to improve the facial recognition biometrics matching process by applying a statistical analysis to the matching of an individual with multiple probe images to an individual with multiple enrolled images. The method uses two compensation tables to provide an overall matching score based on the percentage of matches between the probe individual collection of images and the enrolled individual collection of images, as well as the strength of the individual matches. The method results in a final score that represents a comparison of the oddities in the individual probe-enrollment matches.

The present invention claims priority to U.S. patent application Ser. No. 60/762,524, filed on Jan. 27, 2006, the entire disclosure of which is incorporated herein.

The present invention encompasses a method to improve the facial recognition biometrics matching process by using a statistical analysis to adjust the overall score for instances where multiple probe images of an individual and multiple enrollment images of an individual are available. Extensive field-testing has proven that this method is able to significantly reduce false matches that are caused by the random occurrence of a probe image matching an enrollment image. This method has specifically proven to be successful in reducing false matches and false non-matches for facial recognition surveillance applications.

### BACKGROUND

The majority of current biometric matching is comprised of a single probe template (template: the mathematical representation of a biometric identifier) against a single enrollment template or, at most, a small number of enrollment templates, where “probe” refers to an image to be compared and “enrollment” refers to an existing image to which the “probe” is compared. Any match above a predefined threshold of the single probe template and one of the enrollment templates results is considered a success.

Biometrics are based on the probability of an accurate match. This means that every biometric technology is susceptible to false matches and false non-matches. A poor-quality probe image or poor-quality enrollment image can result in an inaccurate match.

In instances when multiple probe templates for a subject and multiple enrollment templates for a subject are available, the current invention of a statistical method adjusts for inaccuracies resulting from a poor-quality enrollment image matching the wrong person, a poor-quality probe image matching the wrong enrollment, or combinations of the two.

The conventional methods of matching multiple enrollment templates with a single probe template are one of the following:
1. One of the match scores must be equal to or higher than the threshold.
2. All of the match scores must be equal to or higher than the threshold.
3. A predefined percentage of the match scores must be equal to or higher than the threshold.

The problem lies in the fact that the conventional methods rely on the accuracy of the facial recognition biometric matching alone and do not take into account errors that may be generated by poor-quality probe and/or enrollment images.

As an example, a probe image generated while a person's face is rotated to a certain angle will result in an inaccurate representation of the person's true facial dimensions. Based on the conventional methods above, if the inaccurate probe template matches an enrolled subject above the predefined threshold, the result will be a match (albeit a false match), even though a true representation of the probe subject would not normally match the enrolled subject. The statistical analysis of multiple probe images would likely remove this type of false match.

Thus, the conventional methods of matching lead to higher false match and false non-match rates, especially in surveillance-type applications where the subject is either non-participatory or non-cooperative and his/her movements cannot be controlled.

### SUMMARY

A computer and/or processing system may be used for implementing the statistical analysis for determining the accuracy of a facial recognition algorithm, encompassed by the present invention, as further described below. This invention encompasses a method of enhancing the facial recognition biometric matching technique by applying a statistical analysis to the matching of an individual with multiple (more than one) probe images to an individual with multiple (more than one) enrolled images. The method uses two compensation tables to provide an overall matching score based on the percentage of matches between the probe individual collection of images and the enrolled individual collection of images, as well as the percentage match score of the individual matches.

This method provides a more accurate biometric matching result for instances where multiple probe images of an individual and multiple enrollment images of an individual are available. Each individual probe image and each individual enrollment image are matched against each other. The results of the individual matches are placed in a matrix. A predefined percentage threshold determines whether or not the resulting score of each probe-enrollment match is considered viable. An average of only the viable matches is generated for each probe image.

A multiplier tool is then used to adjust each of the aforementioned average scores, based on the percentage of total viable matches resulting from the probe-enrollment matching. A predefined percentage threshold determines whether or not the multiplier tool results in a viable adjusted score. Based on the percentage of total viable multiplier-adjusted scores, the average of only the viable multiplier-adjusted scores is then adjusted by an additional multiplier. The final score represents a compensation for oddities in the individual probe-enrollment matches.

The utilization of multiple probe templates and multiple enrollment templates through the statistical matching technique reduces the chance that a single bad probe or enrollment template results in a seemingly accurate match. The end product of the statistical matching technique is a final percentage match that represents an adjusted score used to determine the validity of the match.

### BRIEF DESCRIPTION OF THE DRAWINGS

The accompanying diagrams illustrate the statistical match method and examples of the calculations that comprise embodiments of the invention. The text below further describes the diagrams.

FIG. 1. Overview of the process

FIG. 2. Example of Normal Match Calculation case #1

FIG. 3. Example of Normal Match Calculation case #2

FIG. 4. Example of Normal Match Failure

FIG. 5. Example of Match with Single Inconsistent Enrollment Image

FIG. 6. Example of Match with Single Inconsistent Probe Image

### DETAILED DESCRIPTION

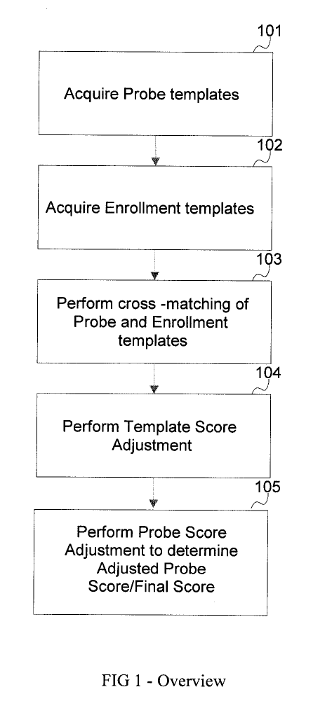

FIG. 1. The first diagram is an overview of the procedural steps that describe embodiments of the invention. The process begins by acquiring a series of probe templates 101 of a given person, generated by a facial recognition algorithm that converts the probe images into templates, which are mathematical representations of the image. The method then gathers a set of enrollment templates 102 against which the probe templates are to be matched.

The process then performs a biometric cross-matching process 103 of each individual probe template (P) and each individual enrollment template (E). The results are shown in a biometric match matrix (BMM(P,E)) with size of Np×Me, with “N” and “M” representing variables for the number of probe and enrollment templates, respectively. The matrix consists of the biometric match scores of each probe template against each enrollment template. The result of each probe template and each enrollment template (also known as the individual probe/enrollment matches) is inserted into the appropriate biometric match matrix box, with the rows representing Probe templates and the columns representing the Enrollment templates.

The Raw Average Probe Score (RAPS) is the average of the individual probe/enrollment match scores for each probe (meaning each probe has its own RAPS). Only the individual probe/enrollment match scores above a predefined Analysis Threshold (AT) are included in the Raw Average Probe Score (RAPS). The Analysis Threshold (AT) is a configurable percentage, below which a given individual probe/enrollment match score is considered unsuited for further analysis.

The Adjusted Template Score (ATS) 104 process calculates the probe match percentage based on the number of matched templates above the predefined Matching Threshold (MT), divided by the total number of enrollment templates. The resulting template percentage for each probe has an associated multiplier in the Template Percentage Compensation Table (TPCT). The RAPS is multiplied by its respective scalar from the TPCT.

Each probe has its own ATS [n]. An average of each ATS above the MT is generated by dividing the sum of the ATS's above MT by the number of ATS's above MT. The percentage of total ATS's above the MT is then entered into the Probe Percentage Compensation Table (PPCT) to provide the appropriate scalar for the Final Score, or Adjusted Probe Score.

To calculate the Adjusted Probe Score (APS) 105, the Average ATS is multiplied by the appropriate scalar. The result is the APS (Final Score). If either the ATS or Final APS scores are greater than 100, the score is adjusted to equal 100. This is because the scoring system is based on percentages out of 100 and an ATS or Final APS score greater than 100 is possible.

The following terms are used to further describe embodiments of the present invention.

Raw Average Probe Score=RAPS (average of match scores above the Analysis Threshold)

Analysis Threshold=AT

Matching Threshold=MT

Adjusted Template Score=ATS

Number of Qualified Matches=NQM (number of matches above AT)

Number of Qualified RAPS=NQR (number of RAPS above MT)

Template Percentage Compensation Table=TPCT (a)

Probe Percentage Compensation Table=PPCT (b)

Qualified Match Percentage=QMP (percentage of probe matches above MT)

Qualified ATS Percentage=QAP (percentage of ATS above MT)

Number of Probes=Np

Probe Number=n

Number of Templates=Me

Template Number=m

Adjusted Probe Score=APS (Final Score)

The following equations are used to generate the match score:
Raw Average Probe Score:

$$RAPS [ n ] = \frac{{\sum }_{m = 1}^{Me} BMM ( n , m ) \geq AT}{NQM}$$

Adjusted Template Score:
ATS[n]=RAPS[n]×TPCT(QMP) if ATS[n]>100, Set ATS[n]=100
Result:

$$Final . APS = \frac{{\sum }_{n = 1}^{NQR} ATS [ n ]}{NQR} \times PPCT ( QAP )$$

if Final.APS>100, set Final.APS to 100

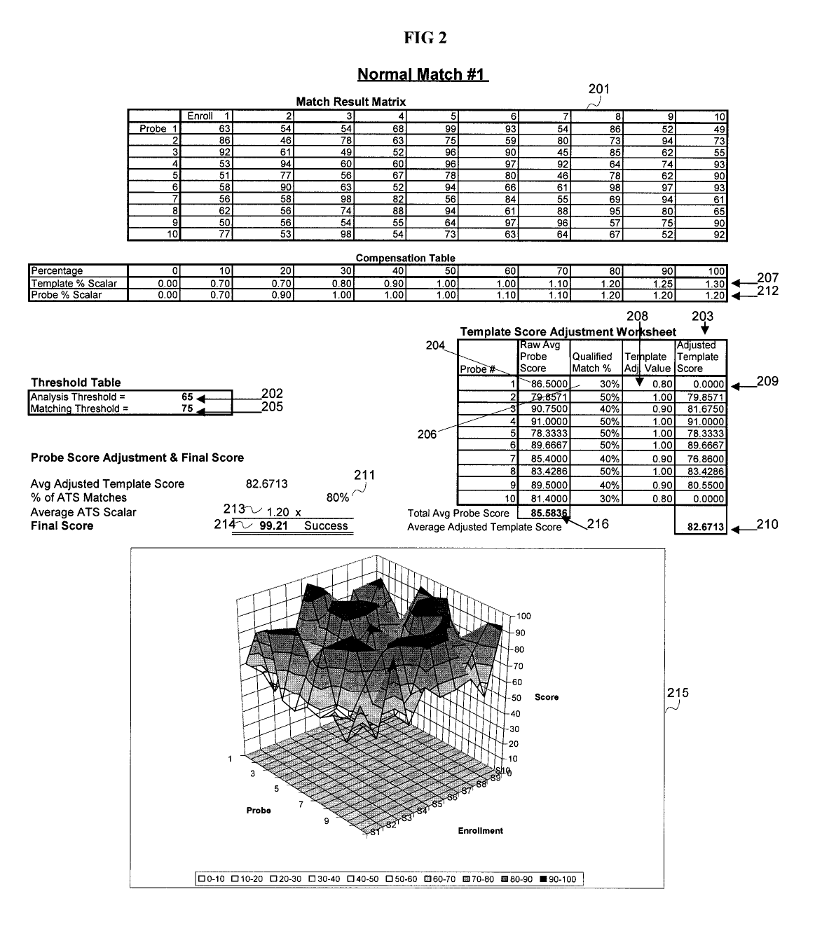

FIGS. 2 to 6 further illustrate the described method and possible results. The TPCT below is adjustable based on the requirement. As an example, if the operation environment is designed to have 3 different angles of the subject's face, the system will expect to generate a strong match from probes captured at these angles. In this scenario, a Qualified Match Percentage (QMP) of 30% should receive a scalar of 1.0, and above 30% should receive a scalar of 1.1-1.3. The Matching Threshold (MT) can be configured according to circumstances; in the examples disclosed herein, the MT is selected to be 75.

FIG. 2. The second figure is an example of a normal match calculation found by using the statistical analysis described above.

The match matrix 103 is shown as the Match Result Matrix 201. In this example, the matrix is comprised of ten probe and ten enrollment templates. The probe and enrollment templates are cross-matched using the facial recognition algorithm and the results are provided in the appropriate spaces.

Following the rules of the Adjusted Template Score (ATS) 104 process, the match scores of probe 1 {63,54,54,68,99,93,54,86,52,49} above the Analysis Threshold (AT=65) 202 results in a subset of qualified probes {68,99,93,86}. Since the sum of the qualified matches is 346 and the number of qualified matches is 4, the Raw Average Probe Score (RAPS) is 86.5 204 (364/4). The Qualified Match Percentage (QMP) 206 is equal to the number of probe matches above the MT (MT=75), {99,93,86}, i.e. three probe matches, divided by the total number of probe templates, which is ten. The resulting calculation for the QMP is 3/10=30% 206.

Using the Template Percentage Compensation Table (TSTC) 207, the corresponding Template Percentage Scalar value based on the QMP is 0.8 208. The RAPS (86.5) is multiplied by 0.8 to produce the Adjusted Template Score 209 (ATS), which equals 69.2. Because this is lower than the MT (MT=75), a “0” is placed in the appropriate ATS box and the probe is not used for further calculation.

Continuing with the rules of the Adjusted Template Score (ATS) 104 process, the match scores of probe 2 {86,46,78,63,75,59,80,73,94,73} above the Analysis Threshold (AT=65) results in a subset of qualified probes { 86,78,75,80,73,94,73}. Since the sum of the qualified matches is 559 and the number of qualified matches is 7, the Raw Average Probe Score 204 (RAPS) is 79.8571. The Qualified Match Percentage 206 (QMP) is equal to the number of probe matches above the MT (MT=75) {86,78,75,80,94} divided by the total number of probe templates. The resulting calculation for the QMP is 5/10=50%.

Using the Template Percentage Compensation Table (TPCT) 207, the corresponding Template Percentage Scalar valued 208 based on the QMP is 1.0. The RAPS (79.8571) is multiplied by 1.0 to produce the Adjusted Template Score 209 (ATS), which equals 79.8571. Because this is higher than the MT (MT=75), the resulting ATS (79.8571) is placed in the appropriate ATS space.

The process is repeated until all probe results are analyzed and ATS 209 values are calculated.

The Average ATS 210 is then calculated by dividing the sum of the qualifying ATS values above the MT (MT=75) {79.8571, 81.675, 91.0, 78.3333, 89.6667, 76.86, 83.4286, 80.55} by the number of qualifying ATS values (8). The Average ATS value 210 is 82.6713.

The Qualified ATS Percentage 211 is then calculated by dividing the number of ATS values above the MT by the total number of probes (8/10=80%). The Probe Percentage Compensation Table (PPCT) 212 is used to identify the appropriate Probe Percentage Scalar 213. The corresponding scalar is 1.20. The ATS Average 210 (82.6713) is then multiplied by the Probe Percentage Scalar 213 to produce the Adjusted Probe Score (APS) or final score 214: 99.21. Because the final score is above the MT, the match result is considered successful.

The 3D chart 215 illustrates the results of this matching process. As shown in the chart, most of the graph is above the MT 205 of 75.

The Total Average Probe Score 216 (85.5836), which is the average of the qualified Raw Average Probe Scores, is the conventional result when multiple probes are evaluated. The conventional methods of matching multiple probe templates to multiple enrolled templates would likely produce this resulting Score.

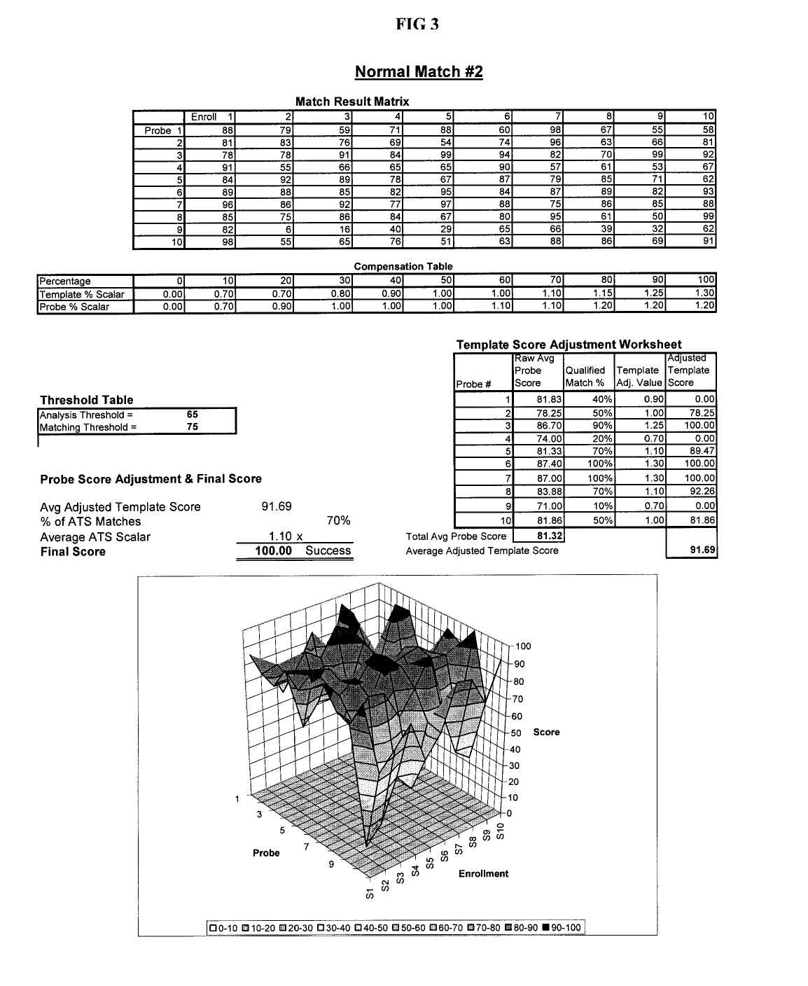

FIG. 3. The third figure is an example of a successful match scenario based on the statistical analysis described above. This example illustrates a successful match with two Raw Average Probe Scores (RAPS) below the Matching Threshold (MT). As shown in the example labeled “Normal Match #2,” the Adjusted Probe Score (APS) Final Score is 100.00, indicating a very strong match.

The Total Average Probe Score (81.32), which is the average of the qualified Raw Average Probes Scores (RAPS), is the conventional result when multiple probes are evaluated. The Total Average Probe Score is still considered a successful result, however, the APS Final Score (100.00) is a significantly stronger match.

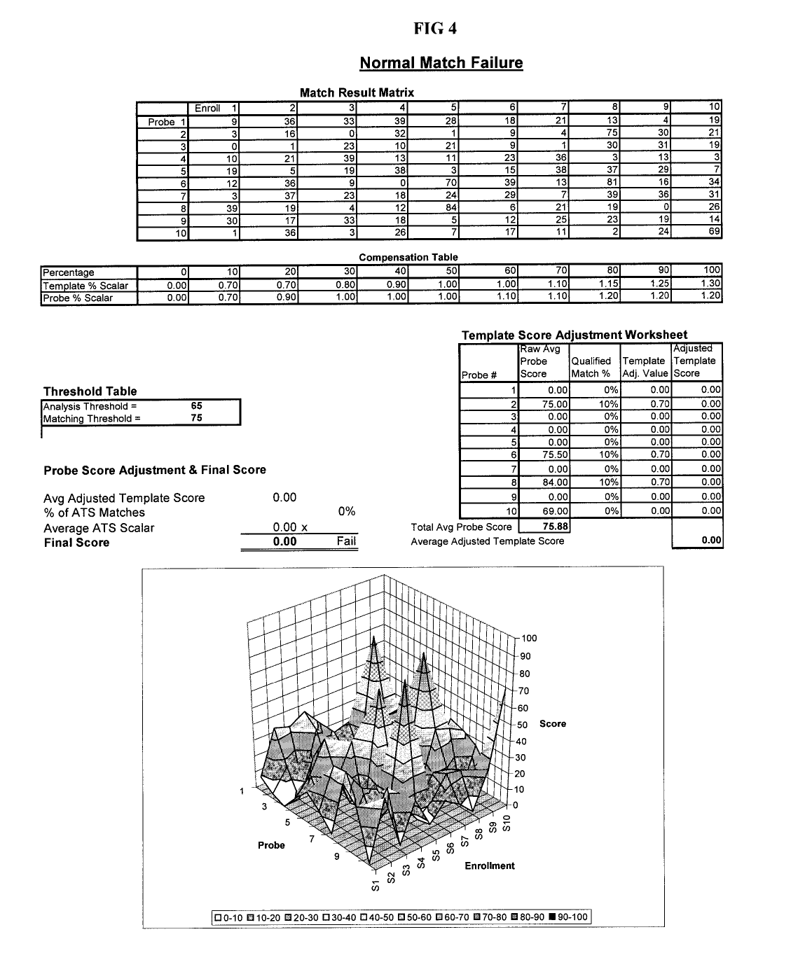

FIG. 4. The third figure is an example of a match failure (or unsuccessful match) based on the result of the statistical analysis described above. This scenario illustrates the results of an unsuccessful match of multiple probe templates to multiple enrolled templates. As shown in the example, the ATS and APS Final Score are “0.”

This example is relevant to the concepts of the invention because the Total Average Probe Score would likely be used to determine the result using conventional methods. The Total Average Probe Score for this scenario would be 75.88. Because the Matching Threshold is set to 75, the result would be a successful match (albeit a false match).

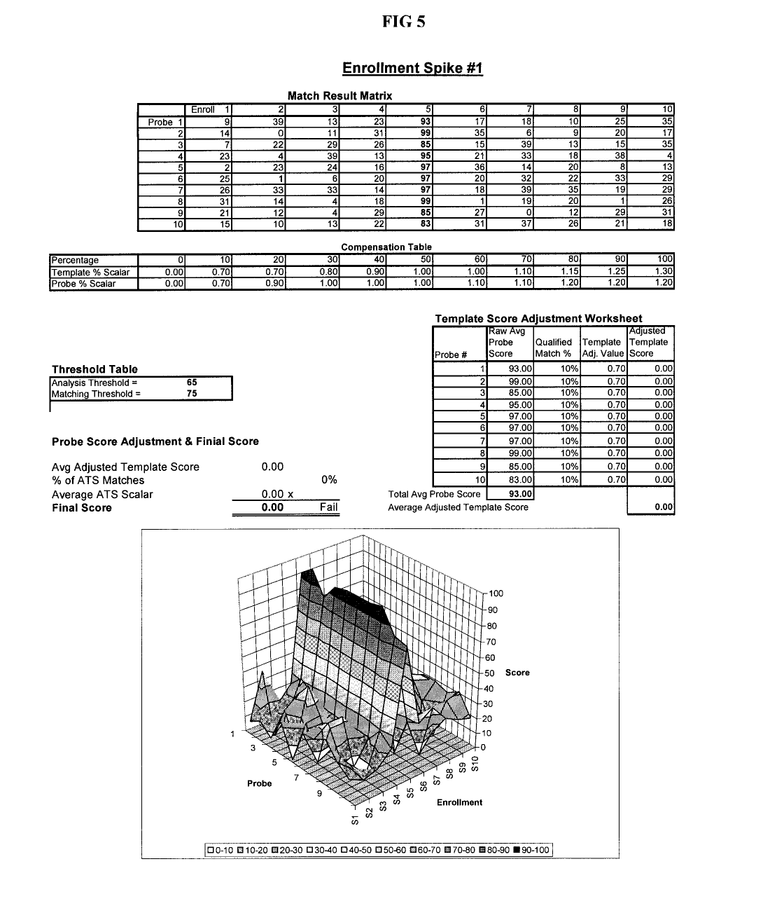

FIG. 5. The fourth figure is an example of a match failure due to an oddity caused by a single enrolled template. Enrolled Template “5” results in a very strong match with all 10 probe templates. This situation may be caused simply because one of the enrolled subject's templates is similar to the probe templates.

As illustrated in the tables and corresponding graph, the statistical analysis compensates for this odd occurrence by recognizing that only 10% of the total probe templates match the enrolled templates. The average ATS is “0,” and consequently the APS Final Score is “0.”

This example is relevant to the invention because the Total Average Probe Score would likely be used to determine the result using one of the conventional methods of multiple template matching. The Total Average Probe Score for this scenario would be 93.00. Because the Matching Threshold is set to 75, the result would be a successful match (albeit a false match).

The template compensation table used in this example suggests that only in instances where 50% or more matches above the Matching Threshold are considered an equal chance match. The illustrated example of only 10% viable matches causes the system to reduce the score accordingly.

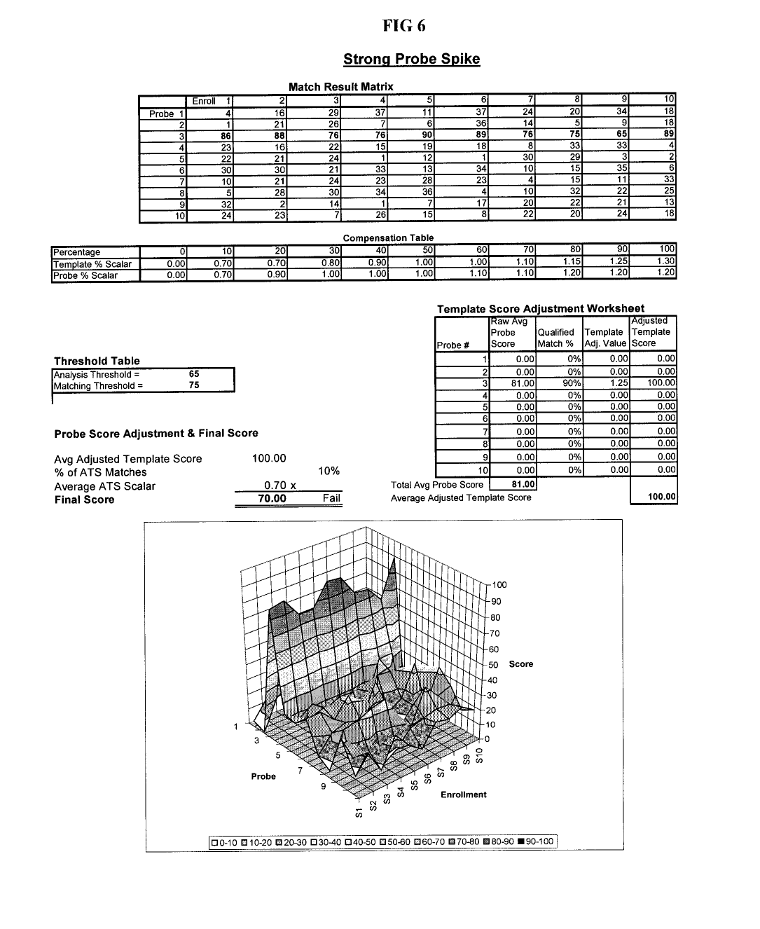

FIG. 6. The fifth figure is an example of a match failure due to an oddity caused by a single probe template. Probe Template “3” results in strong matches with all 10 enrolled templates. This situation may be the result of Probe Template 3 representing an image captured at an angle that caused the probe subject to appear biometrically similar to the enrolled subject.

As shown in the tables and corresponding graph, Probe Template “3” results in an Adjusted Template Score of 100. This is because Probe Template “3” matches 90% of the enrolled templates above the Matching Threshold. The Raw Average Probe Score (81.00) is multiplied by the corresponding scalar (1.25). When calculating the APS however, the corresponding Probe Percentage Scalar for 10% is 0.7, resulting in the Final Score of 70. Because the Match Threshold is set to 75, the result is a failure or non-match.

This example is relevant to the invention because the Total Average Probe Score would likely be used to determine the result using one of the conventional methods of multiple template matching.

The Average Probe Score for this example is 81.00. Because the Matching Threshold is set to 75, the result would be a successful match (albeit a false match).

It is contemplated that one of ordinary skill in the art may make numerous modifications to the method, system, computer, and computer-readable medium of the present invention without departing from the spirit and scope of the invention as defined in the following claims. For example, the present invention can be implemented via hardware or software, as would be understood by those of ordinary skill in the art.

1. A method for calculating the accuracy of a facial recognition algorithm, comprising:
acquiring a probe template;
acquiring an enrollment template;
cross-matching the probe template and the enrollment template, using a facial recognition biometric algorithm to calculate a biometric match score;
adjusting a template score;
adjusting a probe score;
calculating an adjusted probe score;
and determining that the facial recognition algorithm is accurate if the adjusted probe score is greater than a predetermined matching threshold.

2. The method of claim 1, wherein a series of probe templates are acquired, said probe templates being related to the same object, and wherein said probe templates are generated by a facial recognition algorithm.

3. The method of claim 1, wherein a series of enrollment templates are acquired, said enrollment templates being related to the same object, and wherein said enrollment templates are generated by a facial recognition algorithm.

4. The method of claim 1, wherein the biometric match scores are represented in a match result matrix, and wherein said matrix consists of the biometric match scores.

5. The method of claim 4, further comprising comparing the match score to a predefined threshold for each biometric match score.

6. The method of claim 5, further comprising calculating a raw average probe score (RAPS), wherein said RAPS is demonstrated by Formula 1:
$$RAPS [ n ] = \frac{{\sum }_{m = 1}^{Me} BMM ( n , m ) \geq AT}{NQM} \qquad [ Formula 1 ]$$
wherein RAPS[n] is the raw average probe score of n match scores; Me represents the number of enrollment templates; BMM(n,m) is the biometric match matrix; AT is the analysis threshold, which is a configurable percentage; and NQM is the number of qualified matches above the analysis threshold.

7. The method of claim 6, wherein the adjusted template score is represented by the following Formula 2:
ATS[n]=RAPS[n]×TPCT(QMP) [Formula 2]
wherein ATS[n] represents the adjusted template score; RAPS[n] is the raw average probe score of n match scores; QMP represents the percentage of probe matches above a predefined matching threshold (MT), and TPCT represents the variable from the Template Percentage Compensation Table based on the QMP.

8. The method of claim 7, wherein if the value of ATS[n] is less than the matching threshold, the value of ATS[n] is set to zero (0).

9. The method of claim 7, wherein if the value of A TS[n] is greater than one-hundred (100), the value of ATS[n] is set to one-hundred (100).

10. The method of claim 8, wherein the final adjusted probe score is represented by the following Formula 3:
$$Final . APS = \frac{{\sum }_{n = 1}^{NQR} ATS [ n ]}{NQR} \times PPCT ( QAP ) \qquad [ Formula 3 ]$$
wherein Final.APS is the final adjusted probe score; ATS[n] is the adjusted template score of n scores; NQR is number of RAPS above the MT; QAP is the percentage of ATS above the MT, and PPCT is the Probe Percentage Compensation Table based on the QAP.

11. The method of claim 9, wherein if the value of Final.APS is greater than one-hundred (100), the value of Final.APS is set to one-hundred (100).

12. A system for calculating the accuracy of a facial recognition algorithm, comprising:
a device for acquiring a probe template;
a device for acquiring an enrollment template;
a device for cross-matching the probe template and the enrollment template;
a device for adjusting a template score;
a device for adjusting a probe score; and
a device for calculating an adjusted probe score;
wherein the system determines that the facial recognition algorithm is accurate if the adjusted probe score is greater than a predetermined matching threshold.

13. A computer comprising a CPU processor, a display, memory, and input/output, wherein the computer is connected to a database storage unit and receives information to calculate the accuracy of a facial recognition algorithm, wherein the computer is configured to:
acquire a probe template;
acquire an enrollment template;
cross-match the probe and enrollment templates;
adjust a template score;
adjust a probe score; and
calculate an adjusted probe score;
wherein the computer determines that the facial recognition algorithm is accurate if the adjusted probe score is greater than a predetermined matching threshold.

14. A computer-readable medium storing instructions, the instructions comprising:
directing a device to acquire a probe template;
directing a device to acquire an enrollment template;
directing a device to cross-match the probe and enrollment templates;
directing a device to adjust a template score;
directing a device to adjust a probe score;
directing a device to calculate an adjusted probe score; and directing the computer to indicate that the facial recognition algorithm is accurate if the adjusted probe score is greater than a predetermined matching threshold.
